(19) United States
(12) Patent Application Publication
(10) Pub. No.: US 2026/0170833 A1
(43) Pub. Date: Jun. 18, 2026

(54) MACHINE LEARNING (ML)-BASED ANALYSIS OF MULTIPLE SIMULTANEOUS EVENTS IN A VIDEO

(71) Applicants: Constructor Technology AG, Schaffhausen (CH); Constructor Education and Research Genossenschaft, Schaffhausen (CH)

(72) Inventors: Anton AFANASEV, Singapore (SG); Sergey ULASEN, Singapore (SG); Andrei BOIAROV, Sofia (BG); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 18/985,164

(22) Filed: Dec. 18, 2024

(51) Int. Cl. G06V 20/40; G06V 10/25; G06V 10/26; G06V 10/62; G06V 10/774; G06V 40/10; G06V 40/20

(52) U.S. Cl. CPC G06V 20/44; G06V 10/25; G06V 10/26; G06V 10/62; G06V 10/774; G06V 20/41; G06V 20/49; G06V 40/10; G06V 40/20

(57) ABSTRACT

Disclosed herein are systems and method for a machine learning (ML)-based analysis of multiple simultaneous events in a video. In one aspect, a method includes: obtaining a video of objects that potentially involved in an activity; identifying the objects in the video by analyzing the video using a trained object detection ML model; cropping the video into a plurality of video clips; obtaining a list of roles for the activity and a list of actions associated the role; determining a role for each object involved in the activity by analyzing actions and/or interactions with the objects for each object by executing a trained role recognition ML model in each video clip; and evaluating a performance for each object in their role while performing the activity using a trained performance evaluation ML model.

### FIELD OF TECHNOLOGY

The present disclosure relates to the field of machine learning, and, more specifically, to systems and methods for analysis of multiple simultaneous events in a video using neural networks.

### BACKGROUND

Race car pit crews need to be “finely-tuned machines” in motorsports as they execute precise actions with split-second timing. Every member of the crew or object involved in the activity has a designated role, from tire changers and fuelers to doors or wheels of the car, all working in synchronized harmony to minimize the car's time off the track. Crews require speed and precision, where mechanics must change tires, refuel the car, make quick adjustments, and sometimes even repair damage in a matter of seconds. Each movement is rehearsed countless times to ensure efficiency, as even the smallest delay can cost valuable positions in a race where milliseconds determine success.

Despite their expertise, pit crews constantly seek optimization in their actions. Techniques evolve, equipment improves, and strategies are refined with each race. One area for enhancement lies in reducing pit stop times further without compromising safety or accuracy. Innovations in tools and technology play a crucial role, such as lightweight, high-performance jacks and faster refueling systems. Moreover, improving communication and coordination among team members can shave off precious fractions of a second. Analyzing data from each pit stop allows crews to identify bottlenecks and inefficiencies, driving continuous improvement in their performance.

### SUMMARY

To address the shortcomings of preparing and reviewing conventional video analysis, the present disclosure describes preparing machine learning models to identify objects potentially involved in an activity or people's interactions with the identified objects with while performing a particular activity in a video, to determine a role for each object involved in the activity by analyzing actions and/or interactions with the objects for each person, and evaluating a performance for each object in the determined role while performing the activity. Some of the technical improvements of the present disclosure include the precision and speed in identifying people or objects in a video source, and determining a particular role for each object or person involved in the activity by recognizing the object within the activity or actions of each person, respectively. In addition, another technical improvement of the present disclosure includes evaluating a performance for each object in the activity or person in their role while performing the activity.

In one exemplary aspect, a method for machine learning (ML)-based analysis of multiple simultaneous events in a video, the method comprising: obtaining a video of one or more objects potentially involved in an activity; identifying the one or more objects in the video by analyzing the video using a trained object detection ML model; cropping the video into a plurality of video clips, wherein each video clip shows a single object or related group of objects, actions performed by the object, and selected objects interacted with while performing the activity; obtaining a list of roles for the activity and a list of actions associated with each role; determining a role for each object involved in the activity by analyzing actions and/or interactions with the objects for each object by executing a trained role recognition ML model in each video clip; and evaluating a performance for object in the determined role while performing the activity using a trained performance evaluation ML model by comparing the list of actions associated with the determined role with the actions performed by the object and/or interactions with the objects for the single object in the video clip.

In one aspect, the method further comprises: identifying objects that one or more persons interact with while performing the activity by analyzing the video using the object detection ML model; cropping the video into the plurality of video clips, wherein each video clip further shows a single person and all objects that the one or more person interacts with while performing the activity; determining a role for each person involved in the activity by analyzing actions and/or interactions with the objects for each person by executing the trained role recognition ML model in each video clip; and evaluating the performance for each person in the determined role while performing the activity using the trained performance evaluation ML model by comparing the list of actions associated with the determined role with the actions performed by the person and/or interactions with the objects for the person in the video clip.

In one aspect, the list of actions for each role comprises allowed actions and/or prohibited actions.

In one aspect, the method further comprises generating a dynamic UI for displaying synchronized videos clips of each object or person, wherein each synchronized video clip comprises at least a visual identifier of each person or a visual identifier corresponding to each object.

In one aspect, the method further comprises generating an overlay of an outline of the person or object in the synchronized video clip; and applying the generated overlay on each frame of the person or object in the synchronized video clips.

In one aspect, the method further comprises: preparing the object detection ML model using a training dataset comprising of images of people and a name label identifying each person in the images to visually detect and distinguish between different objects.

In one aspect, the method further comprises: preparing the object detection ML model using a training dataset comprising of images of people and an person label identifying each person in the images to visually detect and distinguish between different people.

In one aspect, the method further comprises preparing a role recognition ML model using a training set comprising of images of objects interacting with an object or person and a role label identifying each action corresponding to how the object interacts with another object or person.

In one aspect, the method further comprises applying a tracking algorithm for the objects on consecutive frames to identify where a particular object was at a particular time or where a particular person was at the particular time; and generating a list of bounding boxes for a range of video frames for each identified object or person.

In one aspect, the method further comprises: cropping the video based on the list of bounding boxes; slicing the video to a video clip with a sliding window; applying the trained role recognition ML model on each shorter clip; and performing post-processing for the results of the trained role recognition ML model to select final event timing.

In one aspect, the method further comprises labeling each individual video clip with a corresponding result of executing the role recognition model for each bounding box of the object or person and a position of the object or person in relation to another object.

In one aspect, the method further comprises executing a trained event detection ML model to recognizing specific role events in the video based at least in part on tracking the person and the object in a sequence of frames of the video, wherein the trained event detection ML model is trained to identify people and their interaction with objects in the video using an events training set comprising of a sequence of frames containing an action performed by a person with an object and an event label identifying the action in the sequence of frames of the video.

According to one aspect of the disclosure, a system is provided for machine learning (ML)-based analysis of multiple simultaneous events in a video, the system comprising at least one memory; at least one hardware processor coupled with the at least one memory and configured, individually or in combination, to: obtain a video of one or more objects potentially involved in an activity; identify the one or more objects in the video by analyzing the video using a trained object detection ML model; crop the video into a plurality of video clips, wherein each video clip shows a single object or related group of objects, actions performed by the object, and selected objects interacted with while performing the activity; obtain a list of roles for the activity and a list of actions associated with each role; determine a role for each object involved in the activity by analyzing actions and/or interactions with the objects for each object by executing a trained role recognition ML model in each video clip; and evaluate a performance for object in the determined role while performing the activity using a trained performance evaluation ML model by comparing the list of actions associated with the determined role with the actions performed by the object and/or interactions with the objects for the single object in the video clip.

In one exemplary aspect, a non-transitory computer readable medium storing thereon computer executable instructions for machine learning (ML)-based analysis of multiple simultaneous events in a video, including instructions for: obtaining a video of one or more objects potentially involved in an activity; identifying the one or more objects in the video and by analyzing the video using a trained /bject detection ML model; cropping the video into a plurality of video clips, wherein each video clip shows a single object or related group of objects, actions performed by the object, and all selected objects that selected (cropped) object interactsed with while performing the activity; obtaining a list of roles for the activity and a list of actions associated with each role; determining a role for each object involved in the activity by analyzing actions and/or interactions with the objects for each object by executing a trained role recognition ML model in each video clip; and evaluating a performance for object in the determined role while performing the activity using a trained performance evaluation ML model by comparing the list of actions associated with the determined role with the actions performed by the object and/or interactions with the objects for the single object in the video clip.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for identifying objects and/or people from a video and determining a role for each object and/or person in the video using machine learning according to aspects of the present disclosure.

FIGS. 2A-2B are an example diagram illustrating an approach of identifying objects and/or people in a video according to aspects of the present disclosure.

FIG. 3 is an example diagram illustrating an approach of cropping a video into a plurality of video clips for each identified person in the video according to aspects of the present disclosure.

FIG. 4 is a block diagram illustrating a system for preparing machine learning models to identify objects and/or people, recognize a role of each object and/or person in the video, and evaluating a performance for each object and/or person in their role while performing the activity according to aspects of the present disclosure.

FIG. 5 is a flow diagram of a method for machine learning (ML)-based analysis of multiple simultaneous events in a video according to aspects of the present disclosure.

FIG. 6 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for machine learning (ML)-based analysis of multiple simultaneous events in a video. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of machine learning (ML)-based analysis of multiple simultaneous events in a video. One aspect involves using machine learning to identify objects potentially involved in an activity and/or people and their interaction with the object with while performing an activity from a video. A second aspect involves cropping the video into a plurality of video clips such that each video clip only shows a single object, person, actions performed by the single person, and or objects that the single person interacts with while performing the activity. A third aspect involves using machine learning determining a role for each object and/or person involved in the activity by analyzing actions of the object and/or interactions with the objects for each person in each video clip. A fourth aspect involves using machine learning to analyze a performance for each object and/or person in their role while performing the activity in order to evaluate or grade the performance of each object and/or person in the activity.

First, consider that within any video, there may be dozens of objects potentially involved in an activity and dozens of people performing a particular task as part of an activity in the same video stream. As a non-limiting example, in a video stream of a race pit stop, each crew member has a very specific role with particular tasks that must be performed simultaneously on the race car. In addition, each crew member may closely resemble each other due to wearing similar uniforms, similar colors, or having similar equipment. Furthermore, camera angles such as top view angles may not be able to properly show objects and/or uniforms of the crew member at that particular camera angle such that it is difficult to identify objects, identify crew members, track what crew members are doing, or see the objects that crew members are interacting with. Accordingly, image recognition using machine learning may be utilized to identify and learn visual appearances of objects and/or crew members and then use the trained machine learning models to identify each object and/or crew member within a video clip.

Second, during a pit stop, the pit crew must perform a highly coordinated set of tasks to service the race car as quickly as possible. Each crew member has a specific role to ensure that the stop is completed efficiently. For example, a typical Formula 1 pit crew may have up to 20 members, each with a defined task. A front jack operator may lift the front of the car using a front jack as soon as the car stops to allow the front wheels to be removed and replaced. A rear jack operator may left the rear of the car with a rear jack to enable the rear wheels to be changed. There may be four wheel gun operators who are each responsible for using a pneumatic gun to remove and fasten the wheel nuts. These wheel gun operators work in pairs for the front and rear wheels on both sides. For each wheel, there may be a “wheel off and on” person responsible for removing the old tire and another for placing the new tire on. There may be two crew members whose job is to stabilize the car from the side during the stop to prevent it from moving or tilting as the jacks are lifted or lowered. There may be two front and rear wing adjusters to adjust the front and rear wings of the car to fine-tune aerodynamics. There may be a lollipop man/light operator to control the pit stop release system through a light system to indicate to the driver when to safely exit the pit. There may be a fire extinguisher operator to stand by with a fire extinguisher in case of a fire or emergency. There may be two car controllers located at the front and rear to assist in precisely guiding the car into the pit box. Finally, there may be a team member ready to restart the car's engine in case it stalls.

Each crew member must practice extensively to perform these tasks in unison to minimize the time spent in the pit lane. Accordingly, crew members are highly specialized in their roles and precision is critical since even a minor mistake may significantly impact another crew member's job and/or impact the race outcome. Thus, successful pit stops rely on seamless teamwork and communication among all members.

After identifying each object and/or person in the video feed, the present disclosure describes a machine learning based method for recognizing roles for each object and/or person involved in the activity in the video by analyzing their actions and/or interactions with the objects for each person. In addition, each object and/or person may be identified and tracked in the frames of the video using visual characteristics such as their visual appearance, race suits, tools, actions, or relation to other objects in order to evaluate their performance. Machine learning may also be utilized to quantify or evaluate the performance of each object and/or crew member during the activity.

By tracking and analyzing each object and/or crew member's actions during the activity, a user interface (UI) may display synchronized video clips of each object during the activity and/or crew member performing the activity. In addition, the UI may display a playback of each video clip with objects and/or crew members identified by a respective visual identifier such as different colored boxes that track the objects and/or crew members during the activity. During post-race analysis, a user may select a particular object and/or crew member within the UI and the playback of the video will update according to the selected object and/or crew member during the activity. In this way, the dynamic and interactive UI may be easily controlled by support teams or analysts to review the performance of each object and/or crew member and automatically have a dedicated video clip of that object and/or crew member playback.

It should be noted that the present disclosure describes analyzing and evaluating video clips of the objects and/or actions of crew members performing a coordinated set of tasks to service a race car during a pit stop for illustrative purposes only and that the methods and systems described in the present disclosure may be applicable to any activity that involves objects and/or multiple people regularly performing a coordinated set of tasks using objects in a video.

As another non-limiting example, the methods and systems described in the present disclosure may be applicable to a surgical operation in a hospital setting. In this environment, objects may include scalpels, sponges, and clamps, and a team of medical professions may include surgeons, anesthesiologists, nurses, surgical technicians, and other support staff that must work together seamlessly to ensure the safety and success of the procedure. In addition, each object and/or member of the medical team has a specific role that requires specialized skills and knowledge and they must work quickly and in synchronization.

Turning now to the figures, example aspects are depicted with reference to one or more components described herein, where components in dashed lines may be optional.

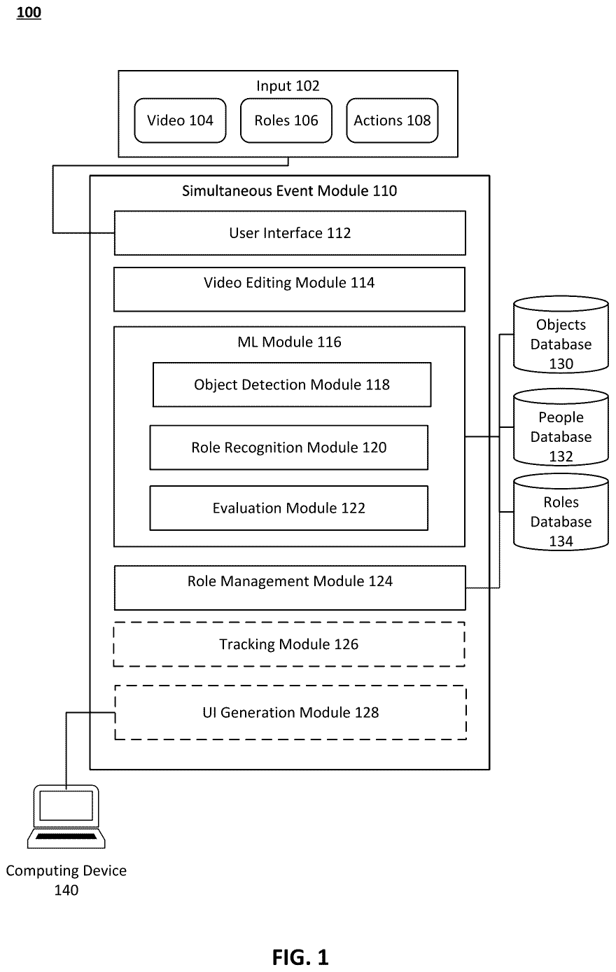

FIG. 1 is a block diagram illustrating a system 100 for analysis of multiple simultaneous events in a video using machine learning. The system 100 may include a computing device 140 and a simultaneous event module 110, which may be a software installed on or accessed (e.g., via a virtual machine, container, web application) on computing device 140. The computing device 140 allows for a user to control and configure the system 100 and also view a UI. Computing device 140 may execute a plurality of modules in the simultaneous event module 110 that together make up an detection, recognition, and analysis system. In some aspects, the simultaneous event module 110 may correspond to a computing device 140 that is configured to execute a plurality of modules that together make up the simultaneous event module 110.

The simultaneous event module 110 is configured to identify objects and/or people within a video involving objects or a team of people performing highly coordinated tasks as part of an activity, recognize a role for each object and/or person in the video, and evaluate a performance for each object during the activity and/or person in their role while performing the activity. In particular, the simultaneous event module 110 may obtain an input 102 that may include a video 104 of object potentially involved in the activity and/or one or more persons involved in an activity. In some aspects, the input 102 may include information or attributes for roles 106 of each object and/or person assigned to the activity. These attributes may indicate information related to the function, performance, qualities, skills, or characteristics required or expected for a particular role. In some aspects, the input 102 for the actions 108 further may include a classification of events (e.g., actions) related to each role.

The simultaneous event module 110 may include a UI 112, a video editing module 114, a machine learning module 116, a role management module 124, an optional tracking module 126, and an optional UI generation module 128. The simultaneous event module 110 may be connected to an objects database 130, a people database 132, or a roles database 134. In some aspects, these databases may be hosted on the computing device 140 or a local machine. In some aspects, these databases may be hosted on a cloud server. In some aspects, the simultaneous event module 110 may generate a UI for display, which may be part of a client application associated with the simultaneous event module 110. For example, computing device 140 may be a device belonging to a pit crew or support team member.

The present disclosure discusses the use of machine learning models (e.g., neural networks) to analyze the performance of each person performing their role during an activity in the video. As a non-limiting example, a race support team member may review videos of recent pit stops during a race based on a video 104, roles 106, and actions 108 for each role to review the performance of each crew member.

The computing device 140 may execute a UI 112 to obtain, from the user, a video 104 (or video feed) of one or more objects and/or persons involved in an activity for the simultaneous event module 110. The simultaneous event module 110 may also receive a listing or description of roles 106 (e.g., wheel, door, front jack operator, rear jack operator, wheel gun operator, or the like) for the activity (e.g., pit stop during a racing event) and a list of actions 108 or events associated with each role (e.g., wheel must be replaced, door must be closed properly, front jack operator must lift the front of the car using a front jack when the car stops, each wheel gun operator must use a pneumatic gun to remove and fasten the wheel nut on their respective wheel).

Given a video 104, a list of roles 106, and actions 108 or events associated with each role, generally, the machine learning module 116 from the simultaneous event module 110 performs a 3-step process to evaluate a performance for each object in the video 104 and/or person in their role while performing the activity in the video 104. First, the object detection module 118 detects objects and/or people based on recognizing visual appearances of the objects and/or people in the video stream. Second, the role recognition module 120 may determine roles of each object and/or person in the video stream based on analyzing the actions and/or interactions with the objects that a person is interacting with in the video clip. Third, the evaluation module 122 may evaluate a performance for each object and/or person in their role by comparing a description or the list of actions 108 associated with the determined roles of the object and/or roles of the actions performed by the person and/or interactions with the objects by the person.

The computing device 140 may execute a video editing module 114 that may crop the video 104 into a plurality of video clips such that each video clip shows a single object and/or person and actions performed by that object and/or person.

The computing device 140 may execute a machine learning module 116 include an object detection module 118, a role recognition module 120, and an evaluation module 122. The machine learning module 116 is trained to analyze the user specified sources (e.g., video 104, roles 106, and actions 108), as well as other known sources (e.g., stored in the objects database 130, people database 132, and roles database 134) to evaluate the performance of each object and/or person in their role. The machine learning module 116 may further analyze the video to identify objects and/or people via the object detection module 118, to crop the video into a plurality of video clips such that each video clip shows a single object and/or person and actions performed by that person via the video editing module 114, and to determine a role based on each video clip via the role recognition module 120. Finally, the machine learning module 116 may evaluate the performance of each object and/or person in their role in the video 104 via the evaluation module 122. All this analysis and information may be gathered and displayed within a dynamic UI, which may display individual video playback for each object and/or person and display an evaluation or score for each object and/or person in their determined role.

In some aspects, the object detection module 118, the role recognition module 120, and the evaluation module 122 may contain specific trained neural network modules. A neural network is a type of machine learning process that uses interconnected nodes or neurons in a layered structure that resembles the human brain. The neural networks create an adaptive system that computers use to learn from their mistakes and improve continuously by comprehending unstructured data and make observations without explicit training. With neural networks, computers may distinguish and recognize images similar to humans. However, the neural networks in the object detection module 118, the role recognition module 120, and the evaluation module 122 must first go through training to teach the neural networks to perform their respective specific tasks.

The machine learning module 116 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 116 may be one of the following: transformer neural network, convolution neural network (CNN), recurrent neural network (RNN), long short-term memory (LSTM) network, gated recurrent unit (GRU) network, autoencoder, generative adversarial network (GAN).

A transformer is a deep learning architecture used in large language models (LLMs). The transformer has an encoder/decoder structure with numerous stacked multi-head attention layers and feed forward network layers. This architecture allows the model to process and generate text effectively, capturing long-range dependencies and contextual information. Transformer are well-suited for tasks like natural language processing, and image classification and generation. Common examples of transformer models are generative pre-trained transformer (GPT) and Bidirectional Encoder Representations from Transformers (BERT).

A CNN is specialized for processing grid-like data, such as images, and employs convolutional layers to learn spatial hierarchies of features, reducing the need for manual feature engineering. CNNs are well-suited for tasks like image classification, object detection, and image generation.

An autoencoder is a type of neural network used for unsupervised learning and dimensionality reduction, and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

For image classification tasks such as object and/or person identification, an untrained neural network in the object detection module 118 will first analyze the images from the training dataset to identify objects and/or people in the images by learning and categorizing distinct visual appearances that define a particular object and/or person. As an example, the training dataset may include labeled training data consisting of images of objects and/or people and their corresponding ground truth labels (e.g., identification of object or person). Accordingly, since the object detection module 118 is designed to classify objects from different classes (e.g., each individual person or object), then the training data will need samples from every object and person that is to be identified. Typically, thousands of samples from each class may be required.

During training of the neural network in the object detection module 118, the training dataset comprises images of the objects and/or people that are input through an untrained neural network model in the object detection module 118. The results from the untrained neural network are then compared with known data set results (e.g., people training set or object training set) using the corresponding object and/or person labels identifying each object and/or person in the images. It should be noted that the input to the object detection module 118 will only be the images from the training dataset.

For every input training sample from the training dataset, the neural network from the object detection module 118 will produce a prediction consisting of values representing the probability that the input image corresponds to a given class (e.g., a given object or person). The output with the highest probability determines the predicted person label or object label. A class label for each input image is used to compute a loss (e.g., loss function).

The object detection module 118 then uses a loss function that quantifies the error between the predicted output and the ground truth (e.g., object label or person label) for a given training sample. In other words, the loss function can be used to guide the learning process by updating the network weights in a way that improves the accuracy of future predictions. This process may continue until the difference between the prediction and the correct targets is minimal.

Once a neural network is trained (e.g., inference), the object detection module 118 may identify objects and/or faces of people, recognize physical attributes of the people, physical attributes of objects and label images to identify the objects and/or people within the images. Specifically, the object detection module 118 contains a trained neural network configured to identify and generate a people visual identifier identifying people and/or an object visual identifier identifying objects in a plurality of images. As such, the object detection module 118 is trained to identify at least one object and/or person in the video based at least in part on identifying visual appearances of each object and/or person using a trained neural network. The trained neural network in the object detection module 118 may use visual cues and appearances of the object and/or people in images such as helmet color, uniform color, a uniform number assigned to the person, or the like to identify individual objects and/or people.

During inference, the trained neural network model from the object detection module 118 does not re-evaluate or adjust the layers of the neural network based on the results. Instead, the inference applies knowledge from the trained neural network and uses it to infer a result (e.g., what people or objects are identified in an image). Accordingly, when a new unknown dataset (e.g., video 104) is input through the trained neural network in the object detection module 118, the trained neural network outputs a prediction of what objects and/or people are present in the videos based on predictive accuracy of the neural network.

In some aspects, the trained neural network from the object detection module 118 may also be executed to generate an object visual identifier for each object and/or a person visual identifier for each person that is continuously overlayed over playback of the video by executing the trained object identification neural network on each frame of the video. The object visual identifier overlayed on the video frames allow viewers of the video to easily identify and track a particular object throughout the activity captured in the video. Similarly, the person visual identifier overlayed on the video frames allow viewers of the video to easily identify and track a particular person throughout the activity captured in the video.

In some aspects, the people and objects may be identified and marked without the use of a trained machine learning model. For example, the people and objects may be manually marked or input by a user into the simultaneous event module 110.

The role recognition module 120 contains a trained neural network configured to recognize the role of the identified person from the plurality of images to determine the role of the identified object and/or person involved in the activity. For example, a specific object such as a wheel may have a specific role in the process of helping the car move. There may be key performance indicators associated with the wheel in relation to the car such as how tightly the wheel is attached, the tire pressure in the wheel, the tread on the wheel, etc. In some aspects, the roles may also be identified and marked without the use of a trained neural network.

Similar to training the object detection module 118, the untrained neural network in the role recognition module 120 will analyze the images from the training dataset and learn to recognize the roles of the identified object and/or people by detecting and learning what distinct patterns, actions, and/or visual appearances define a role in the activity captured in the images. As an example, the training dataset may include labeled role training data consisting of images such as a tire, tire changer and its corresponding ground truth (e.g., identity of the tire or identity of tire changer role) labels. Accordingly, since the role recognition module 120 is designed to classify roles from different classes (e.g., different roles) then the training dataset will need samples of every role.

The role recognition module 120 is trained by inputting a role training dataset comprising images of roles and a role label identifying each role in the images. During training of the neural network, the role recognition training dataset is put through the untrained neural network from the role recognition module 120 and the results from the untrained neural network are then compared with known data set results (e.g., role training set) using the labels.

For every input training sample, the role recognition module 120 will produce a prediction consisting of values representing the probability that the input image corresponds to a given class (e.g., a unique role). The output with the highest probability determines the predicted racer label. It should be noted that the input to the role recognition module 120 will only be the image. A class label for each input image is then used to compute a loss (e.g., loss function).

The neural network in the role recognition module 120 then uses a loss function that quantifies the error between the predicted output and the ground truth (e.g., geolocation label) for a given training sample. In other words, the loss function can be used to guide the learning process by updating the network weights in a way that improves the accuracy of future predictions.

The role recognition module 120 contains a trained neural network configured to identify unique roles in the video, to identify corresponding unique roles of the identified object and/or people in the video using a trained neural network. The trained neural network in the role recognition module 120 may use visual cues and appearances of the identified object and/or people and their interaction with the object in images such as a person holding an air gun, a person removing a lug nut, a person changing the tire, a person securing the tire, or the like to identify the various unique roles in the activity.

In some aspects, the trained neural network in the role recognition module 120 is trained to identify and distinguish between visual appearances of each unique role using a training set having images of the unique roles and a role label identifying each role.

During inference (e.g., when the model makes predictions or evaluations based on the learned knowledge), the role recognition module 120 has a trained neural network that does not re-evaluate or adjust the layers of the neural network based on the results. Instead, the inference applies knowledge from the trained neural network model and uses it to infer a result (e.g., what are the roles of each identified object and/or person in an image). Accordingly, when a new unknown data set (e.g., video 104) is input through a trained neural network in the role recognition module 120, the trained neural network in the role recognition module 120 outputs a prediction of what unique roles each object and/or person is performing in the videos based on predictive accuracy of the neural network.

Evaluating the performance of an object and/or person with a defined role in the activity captured by the video may utilize a machine learning model that involves defining specific performance metrics relevant to their role, collecting data during the activity, and building a model to assess their individual and team performance.

First, each object and/or person has a defined role with specialized tasks so performance metrics will differ based on their role. Going back to the example of a race pit team, some common performance metrics that may be general to all roles involving people include—reaction time (e.g., how quickly each crew member starts their task once the car arrives), task completion time (e.g., time taken to complete their specific task), accuracy/precision (e.g., whether the task was performed correctly without errors), synchronization (e.g., how well the crew member's actions are synchronized with the rest of the team), and safety compliance (e.g., whether the crew member followed safety protocols during the pit stop).

Evaluation module 122 of the machine learning module 116 may also be configured to assign a score or quality level to each object and/or person in reference to how well they performed their role in the activity captured by the video. The evaluation module 122 may define objective metrics (e.g., speed, accuracy/precision, task completion time, etc.), subjective metrics, quantitative metrics (e.g., output, task completion rate, etc.), and/or qualitative metrics (e.g., feedback from peers, communication skills, leadership qualities, synchronization, safety compliance, etc.) for each activity involved in the role. Using these metrics, the evaluation module 122, which may be trained by a trained classification model, may output a quality level for each person. In some aspects, a quality level may be a quantitative value (e.g., a rating out of 10 or a score) or a qualitative value (e.g., “fail”, “poor”, “fair”, “good”, “great”, “excellent”, etc.).

To create a machine learning model in the evaluation module 122, detailed data from the activity capturing both team and individual performance may need to captured. Again, referring back to the pit crew example, the detailed data may include video analysis (e.g., using video 104 from the pit stop to track the movement and timing of each crew member), wearable sensors (e.g., equip crew members with sensors to track motion and physical effort), timing data (e.g., precise timestamps for each action), telemetry data (e.g., race car telemetry data to ensure actions are coordinated), team performance (e.g., overall pit stop time and breakdown of task completion times for the entire crew), and post-stop review (e.g., information on any issues, errors, or penalties during the pitstop).

Depending on the specific goal (evaluating individual performance, predicting errors, improving team coordination), different machine learning models (e.g., supervised learning for performance rating, regression models for continuous performance scoring, unsupervised learning for behavior clustering) may be used in the evaluation module 122.

For example, supervised learning may be used to train the machine learning models if labeled data (e.g., historical performance data is labeled with expert ratings of performances such as excellent, good, needs improvement) is available. In supervised learning, the evaluation module 122 may include classification models such as logistic regression, decision trees, random forests, gradient boosting, or neural networks to determine performance levels based on input features like task completion time, reaction time, and synchronization. These models can be trained on historical data where each activity is labeled according to crew performance.

If a continuous performance metric (e.g., individual task time) is to be predicted, then the evaluation module 122 may use regression models such as linear regression, support vector regression (SVR), random forest regression, or neural networks to predict performance ratings or scores, task completion time, or overall activity contribution score. In this way, the model can predict how well a person's individual performance (task time, accuracy) affects the overall activity.

To discover patterns in each object's and/or individual's role performance without predefined labels, the unsupervised learning is used to train the machine learning models in the evaluation module 122 (e.g., no clear labels). Clustering algorithms such as K-means, DBSCAN, or Hierarchical clustering may be used to group similar object and/or individual behavior. In this way, the evaluation module 122 may find clusters of objects and/or people who consistently perform at high speeds or others who have frequent errors.

In addition, anomaly detection algorithms (e.g., Isolation Forest, Autoencoders) may identify when an individual's performance significantly deviates from the norm (e.g., unusual slow or incorrect execution). In this way, the models can flag potential issues during training or the activity.

If reinforcement learning is used to train the machine learning models in the evaluation module 122 (e.g., targets may adjust based on performance), reinforcement learning can be used to adapt and optimize actions based on feedback received from the environment.

The models in the evaluation module 122 may be trained using historical data that includes input features (e.g., task completion rates, etc.) and corresponding output labels (e.g., performance ratings). The historical data may be split into training and testing sets to ensure that the model generalizes well. In addition, cross-validation may be used to ensure the model's performance is consistent across different subsets of the data. The model accuracy may then be evaluated using metrics such as accuracy, precision, recall, F1-score (for classification models) or mean squared error (MSE), or R-squared (for regression models).

Once the models in the evaluation module 122 are trained, the models should provide predictions or classifications about how well a person is performing in their role. In some aspects, techniques such as SHapley Additive exPlanations (SHAP) or Local Interpretable Model-agnostic Explanations (LIME) to understand what factors are most influencing the predictions of the models.

The models in the evaluation module 122 may provide real-time feedback after each activity, indicating whether each object and/or individual performed optimally or identifying areas of improvement. Over time, the model may track improvements or declines in individual performance, giving the team actionable insight on training needs or optimization. In some aspects, the evaluation module 122 in conjunction with the UI generation module 128 may create visual reports or dashboards showing performance trends, key drivers of the performance, and areas needing improvement for each identified person in their role.

In addition, since conditions in the activity may change, the models may be retrained periodically with new data to ensure it remains accurate and relevant. The model predictions may also use feedback loops to inform coaching and performance improvement plans, then feedback improved data to the model for further fine tuning.

Referring back to the pit stop example, if the evaluation module 122 is evaluating the performance of a tire changer, then the specific metrics for evaluating the tire changer may include reaction time, tire change time, or fastening. The data collection for the tire changer will use video feeds to track movement, wearable sensors to monitor movement of the tire changer, and task-specific telemetry data on the race car or wheel to measure tire change times. A regression model (e.g., Random Forest Regression) can be used to predict how the tire changer's performance affects the overall pit stop time. Feature important analysis may also show if reaction time or task execution speed may be improved.

The computing device 140 may also execute a role management module 124 of the machine learning module 116 configured to manage a listing or description of actions for each role by accessing the roles database 134. In addition, the role management module 124 may define metrics such as time to completion, target time, etc. for each action. Using these metrics, the role management module 124, which may be trained classification model, may output a difficulty level for each role. In some aspects, a difficulty level may be a quantitative value (e.g., a rating out of 5) or a qualitative value (e.g., “easy”, “medium”, “hard”, etc.)

The simultaneous event module may store a list of roles 106 for a particular activity and/or their determined difficulty level in the roles database 134. It should be noted that prior to first use of the simultaneous event module 110 for analyzing a video showing objects and/or people involved in a particular activity, the objects database 130 may need to include at least one object (e.g., wheel) involved in the activity, the people database 132 may need to include at least one person involved in the activity, and the roles database 134 may need to include at least one defined role (e.g., front jack operator) for the activity. A developer of the simultaneous event module 110 may populate the databases with information for each role and each activity. Afterwards, users such as support team members or even the participants themselves can add roles, description and listing of actions for each role, or even images of expected people participating in the activity in each respective database (e.g., objects database 130, people database 132, roles database 134). In some aspects, the objects database 130, the people database 132, and the roles database 134 may be hosted on a cloud server or synchronized across multiple computing devices running the simultaneous event module 110. For example, multiple people or communities may share objects, images of people, roles, description, or listing of actions of the roles over a cloud database or server. As a result, any information related to objects, people, and roles, generated on one computing device may be transmitted by the simultaneous event module 110 to a different computing device over a network (e.g., a local area network (LAN), a wide area network (WAN), etc.) for display on a UI.

The computing device 140 may also execute a tracking module 126 configured to apply a tracking algorithm for the objects and/or people on consecutive frames to identify where a particular object was at a particular time or where a particular person was at the particular time; and generate a list of bounding boxes for a range of video frames for each identified person and object. For example, the tracking algorithm may involve assigning a consistent ID to each detected object and/or person so that it can be identified in subsequent frames. Common object tracking algorithms ay include Kalman Filter, Simple Online and Realtime Tracking (SORT), Deep SORT, Optical Flow such as Lucas-Kanade Optical Flow, Correlation filters such as MOSSE Tracker, CSRT Tracker, and Re-Identification Models.

In order to maintain consistent tracking, the tracking algorithm also needs to associate detected objects and persons in consecutive frames. The process of linking detections across frames is called data association. Common data association techniques may include Intersection over Union (IoU), Euclidean distance for bounding boxes or feature vectors, or a Hungarian Algorithm.

Referring back to the pit stop example, if the tracking module 126 is tracking crew members during a pit stop then the steps include: (1) using an object detection algorithm (e.g., YOLO or Faster R-CNN) to detect objects (e.g., jacks, tire guns) and/or crew members in each frame; (2) using a tracking algorithm like Deep SORT to track each object and/or crew member across frames (e.g., tracking the movement of crew members from when they approach the car to when they complete their task), (3) apply data association techniques (e.g., IoU and Hungarian Algorithm) to ensure that each object and/or crew member maintains a consistent ID as they move around the car to perform their tasks); and (4) use appearance-based re-identification to handle occlusions (e.g., when a crew member is briefly blocked by the car or another team member).

The computing device 140 may also execute a UI generation module 128 configured to receive inputs from a user and generate an interactive and dynamic UI that displays the video, and results from the respective machine learning models. The UI provides a UI for post-race video analysis that displays analysis for each individual object and/or person identified in the captured video 104 and their performance throughout the activity.

It should be noted that the identification of people, objects and roles described in the present disclosure are heavily simplified. One skilled in the art will appreciate that the neural networks utilized may have significantly large datasets with highly specific details. For example, there may be subtle differences between identifying objects potentially involved in an activity and/or people and their interaction with objects in the video. As another example, there may be subtle differences between the actions performed by each object and/or person identified in short video clips. The analysis would be beyond the capabilities of the human mind because the amount of data to be identified and processed within the span of an image or short video clip is unfathomable. In addition, each short video clip may have dozens of objects and people to be distinguished and identified.

It should also be noted that although the present disclosure is described in terms of evaluating multiple events for a pit stop in a racing video for illustrative purposes only, methods and systems described in the present disclosure can be applied to any activity that involves multiple objects and/or people captured in a video.

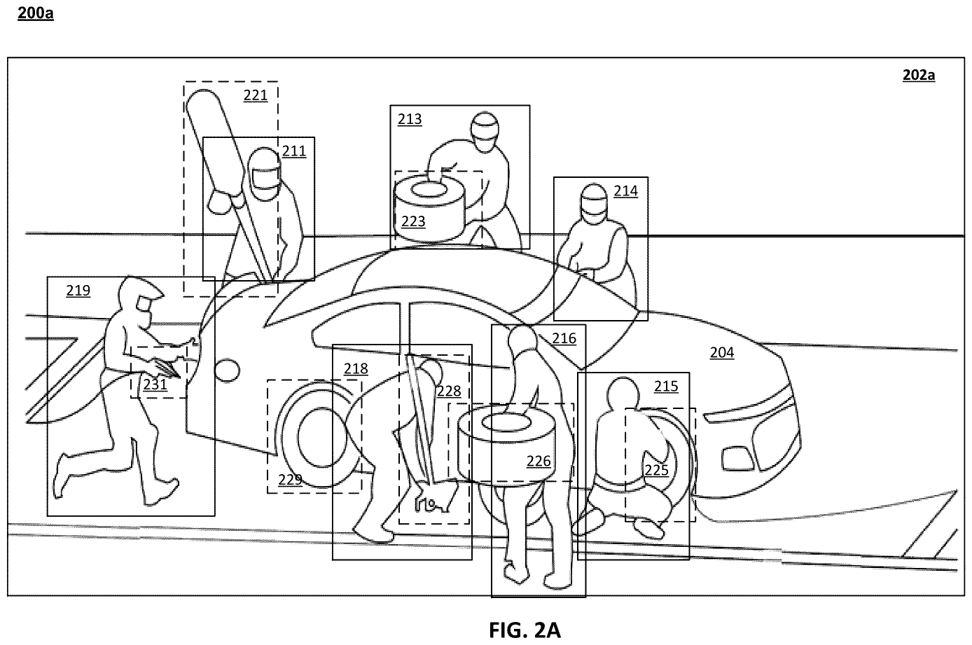

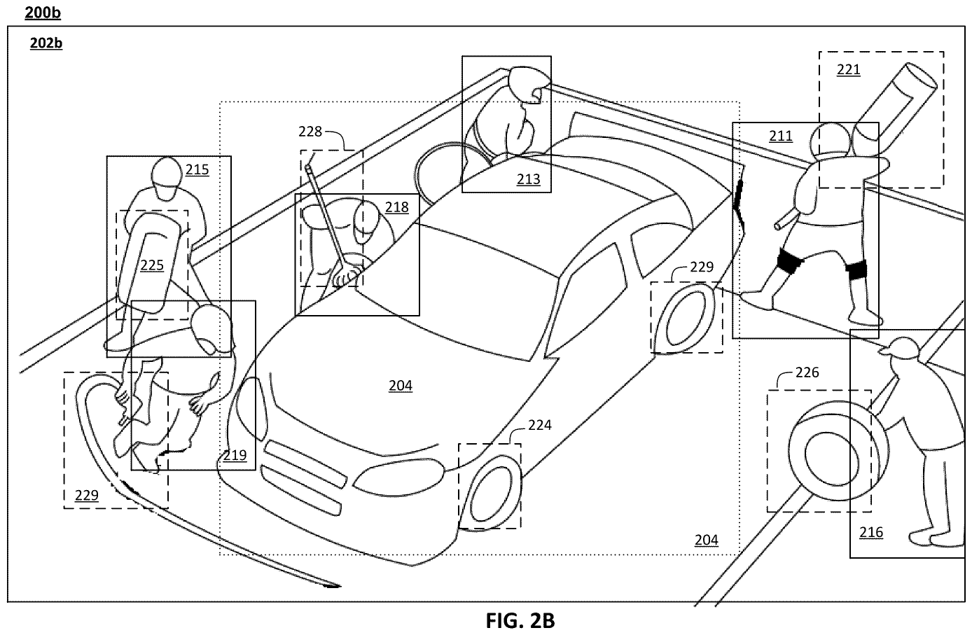

FIGS. 2A-2B are an example diagram illustrating an approach of identifying objects and/or people in a video according to aspects of the present disclosure. Specifically, example 200a of FIG. 2A shows an initial identification of objects and/or people and detection of each object's role and/or person's role in the video clip and example 200b of FIG. 2B shows an analysis of evaluating each object and/or person in their performance of their role in the activity.

Example 200a shows an image 202a from a video (e.g., the video 104 shown in Example 1). As shown in the image 202a, when a car 204 enters the pit stop, a plurality of object 221, 223, 225, 226, 228, 229, 231 and a plurality of crew members 211, 213, 214, 215, 216, 218, 219 initiate the service on the car 204. Suppose that crew member 215 and 219 are assigned to roles of wheel gun operators with the task of replacing tires 229, 226, 223. As shown in example 200a, crew member 215 is positioned to replace the front tire 225. Crew member 219 is approaching a rear wheel 229 with an air gun 231. System 100 may identify the crew members, identify the objects, and analyze the performance of these crew members in their roles and detect any errors.

Example 200b shows an image 202b from the video. As shown in image 202b, after completing a wheel change of the front time, crew member 213 moves to the front wheel 224 on the opposite side when it may have been more efficient for crew member 213 to move towards and round the back of the car 204.

In addition, if the video captures that an air gun 229 has been dropped a number of times, then the trained model in the evaluation module 122 may recognize this and the action of the air gun 229 being dropped will affect the evaluation of the ray gun 229. As another example, if the video captures that the crew member 219 has dropped an air gun 229 a number of times when changing a wheel 225, 229, 226 (e.g., when unscrewing bolts), then a trained model in the evaluation module 122 may recognize this and the actions of droppings the air gun 229 will affect the evaluation of crew member 219. As yet another example, when crew member 219 is changing wheel 224, the evaluation module 122 may flag an error if the direction of the unscrewing does not match the direction that they are supposed to be unscrewing and this incorrect action will also affect the evaluation of crew member 219.

In addition, the evaluation module 122 may also determine whether there is any performance issue in the car, any reduction/increase in average service time, any reduction/increase in average errors, or the like.

It should be noted that mistakes vary in importance. The evaluation module 122 may assign a respective importance value to a respective error based on a combination of how severe the delays it causes, the monetary loss it may cause, and the safety issue it poses. For example, an error involving a jack being dropped near the car may be assigned an importance rating of 2 out of 10 (where 10/10 is highest importance and 1/10 is the lowest importance), which will proportionally affect the evaluation of the person dropping the jack. In contrast to this low importance value, the evaluation module 122 may assign 8/10 to a dropped fuel gun because the car requires fuel to run, the fuel gun may need fixing, and fixed fuel creates a safety hazard, which will also proportionally affect the evaluation of the person dropping the jack.

The evaluation module 122 may include another machine learning algorithm for assigning importance values. The machine learning algorithm may be trained with supervised learning where a dataset is manually curated and includes importance values and the associated delay times, monetary loss values, and/or safety codes associated with potential hazards.

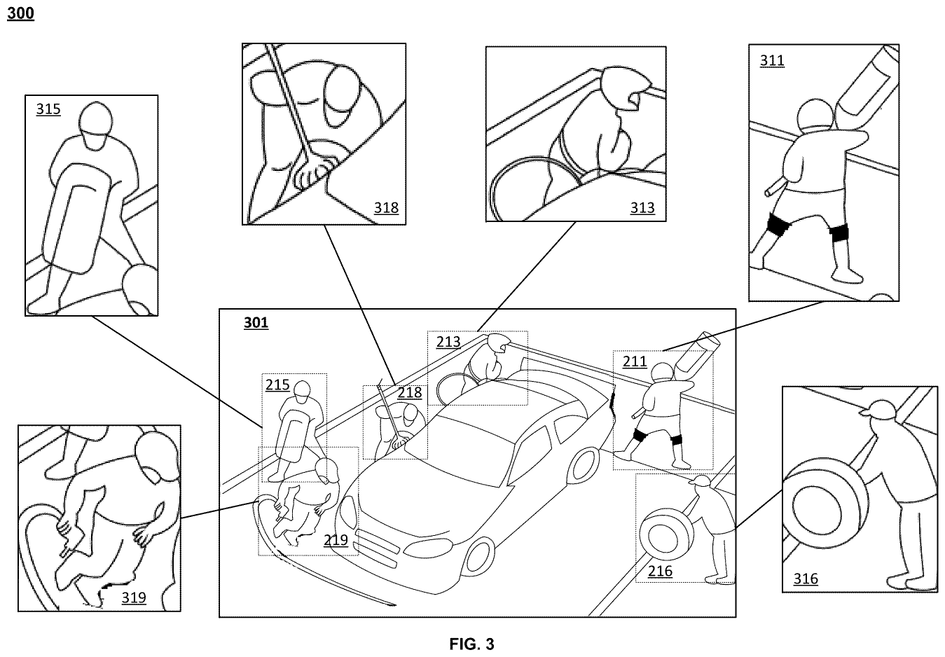

FIG. 3 is an example diagram illustrating an approach of cropping a video into a plurality of video clips for each identified object and/or person in the video according to aspects of the present disclosure.

After each object and/or person is identified in the video 301, the video editing module 114 may isolate and generate an individual video clip for each object and/or person identified in the video. As shown in example 300, crew member 215 has a respective individual clip 315, crew member 218 has a respective individual clip 318, crew member 213 has a respective individual clip 313, crew member 211 has a respective individual clip 311, crew member 216 has a respective individual clip 316, and crew member 219 has a respective individual clip 319. In each individual clip 315, 318, 313, 311, 316, 319 all other people or unnecessary objects (except for the particular crew member for which this video clip is created) are deleted. In some examples, each individual clip may have labels or annotations to identify each person, each object, and their roles. In some examples, each object has a respective individual clip.

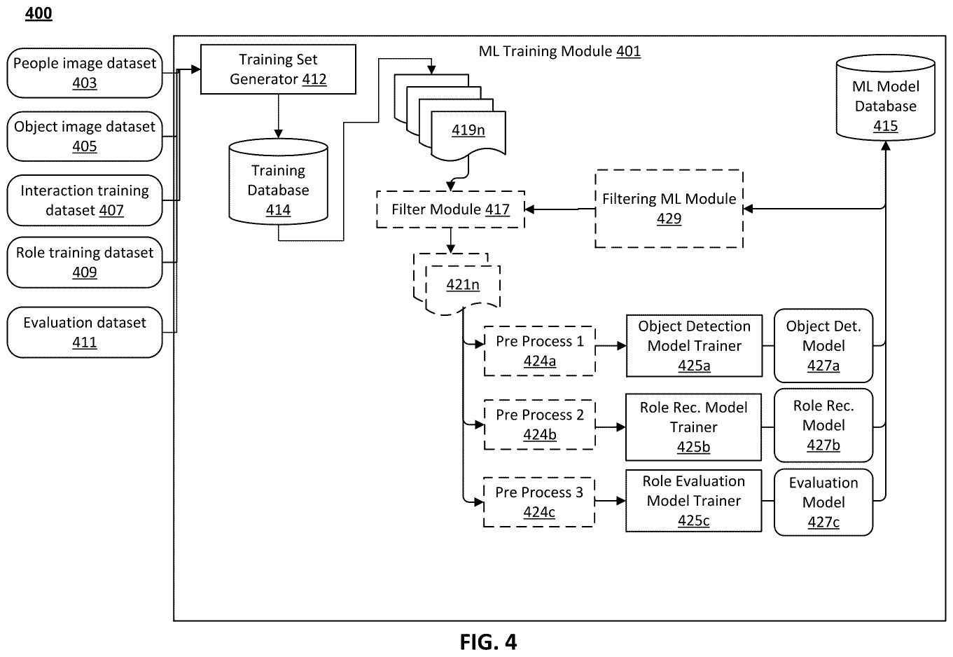

FIG. 4 is a block diagram illustrating a system for preparing machine learning models to identify objects and/or people, recognize a role of each object and/or person in the video, and evaluating a performance for each object and/or person in their role while performing the activity according to aspects of the present disclosure. As shown in example 400, a machine learning training module 401 is configured to build and train specialized machine learning models with inference to perform particular tasks. This enables the specialized machine learning models to develop an ability to perform particular objectives within new images and videos that are not part of a training dataset. By subjecting the specialized machine learning models to large amounts of unlabeled and/or labeled trained image data sets, the specialized machine learning models may perform particular tasks such as identifying and detecting objects and/or people, determining a role for the identified object and/or people, and/or evaluate the identified object and/or people in their roles.

Supervised learning is effective for tasks such as classification (assigning inputs to predefined categories) and regression (predicting continuous values) since it relies on the availability of labeled data for both training and evaluation phases. In supervised learning, the machine learning training module 401 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the machine learning training module 401 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the machine learning training module 401 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the machine learning training module 401 contains at least a training database 414 configured to store the raw training data 419n and corresponding labels, a machine learning model database 415 to store the trained models (e.g., an object detection model 427a, role recognition model 427b, and a role evaluation module 427c). In some aspects, the machine learning module 401 may contain a filtering machine learning model 429 and a filter module 417 configured to filter data from the training database 414 for training by removing bad training images.

Training data from the people image dataset 403, object image dataset 405, interaction image training dataset 407, role training dataset 409, and evaluation dataset 411 is received into the machine learning training module 401 via the training set generator 412. In some aspects, a people image dataset 403 includes images of people and labels identifying the person, an object image dataset 405 includes images of objects and labels identifying the object, an interaction image training dataset 407 includes images of people interacting with the objects and labels identifying the interaction, a role training dataset 409 including images and description of actions defined for each roles and labels for each role, and an evaluation dataset 411 may include historical data that includes input features (e.g., task completion rates, etc.) and corresponding output labels (e.g., performance ratings).

An optional filter module 417 is configured to filter out bad training images and/or data in order to claim up the training data in the training dataset 419n. In some examples, the filter module 417 may be a neural network. In some examples, the filter module 417 is a simple mathematical model. In some examples, the cleaned training dataset 421n then undergoes optional preprocessing steps depending on which neural network or model is being trained.

The optional preprocess 1 424a, preprocess 2 424b, and preprocess 3 424c are automated processes that modify the raw data received from 419n (or cleaned training dataset 421n) and prepare the raw data as input to the respective model trainers (e.g., a people/object detection model trainer 425a, a role recognition model trainer 425b, and an evaluation model trainer). These may be described in the machine learning training module 401 as snippets of code that prepares the datasets. In some examples, the preprocessing module (e.g., preprocess 1 424a, preprocess 2 424b, and preprocess 3 424c) for a particular trainer may be an automated script or code that will be setup the first time any model is trained.

The object detection model trainer 425a, a role recognition model trainer 425b, and an evaluation model trainer 425c are the scripts or code that train the model. The object detection model trainer 425a, a role recognition model trainer 425b, and an evaluation model trainer 425c may be a script or code that holds the instructions on how a model should be trained (e.g., optimization method, model architecture, dataset division, etc.) and also runs the training. The object detection model trainer 425a, a role recognition model trainer 425b, and an evaluation model trainer 425c each take as input the raw or filtered processed training data and train the object detection model 427a, the role recognition model 427b, and the evaluation model 427c to achieve their specific objectives, respectively.

In summary, the raw dataset 419n or cleaned dataset 421n may optionally go through different preprocessing steps 424a, 424b, and 424c and then a corresponding object detection model trainer 425a, a role recognition model trainer 425b, and an evaluation model trainer 425c to generate a trained object detection model 427a, a trained role recognition model 427b, and a trained evaluation model 427c. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 419n used for training may contain noise and bad training images from the training database 414. Accordingly, to create a clean and filtered training dataset, the filter module 417 is configured to filter out unwanted data points from the raw training dataset 419n by developing smaller, less accurate systems based on patterns and metadata information. For example, an automated system may be created to differentiate between different objects and/or people based on the visual appearances used by the first neural network to identify objects including at least a shape, color, or visual appearance and people including at least one of: a helmet color, uniform color, or a number assigned to the person. The resulting training dataset 421n may consist of images and labels, where each image is labeled with a corresponding label such as person name, object, or role.

During the training process, the object detection model trainer 425a, the role recognition model trainer 425b, and the evaluation model trainer 425c (e.g., neural networks) are presented with images and labels, and the optimization objective, which aims to minimize the difference between the actual value and the predicted value, is calculated. The optimization algorithm updates the parameters of the object detection model trainer 425a, the role recognition model trainer 425b, and the evaluation model trainer 425c to reduce the value of the objective. This process is repeated for several iterations until the parameters do not change anymore. This process is repeated for various combinations of hyperparameters, and the model with the smallest label prediction error is selected as the final model.

When a new model (e.g., a trained object detection model 427a, a trained role recognition model 427b, and a trained evaluation model 427c) is created, and a new process for filtering and automated labeling is established, it is added to the machine learning model database 415 in the machine learning training module 401. This enables the new model to be part of the closed-loop model update process. Optionally, at regular intervals, data which is continuously collected can be filtered, labeled, and used to update old models by an optional filtering machine learning module 429. In some examples, the filtering machine learning module 429 is a neural network. In some examples, the filtering machine learning module 429 is a simple mathematical model. This approach may capture changes in the appearance of objects, racers and/or unique geolocations over time. However, if the visual appearances of the objects, racers and/or geolocations remain consistent, the existing large-scale data should be sufficient, and new data may not bring significant additional information.

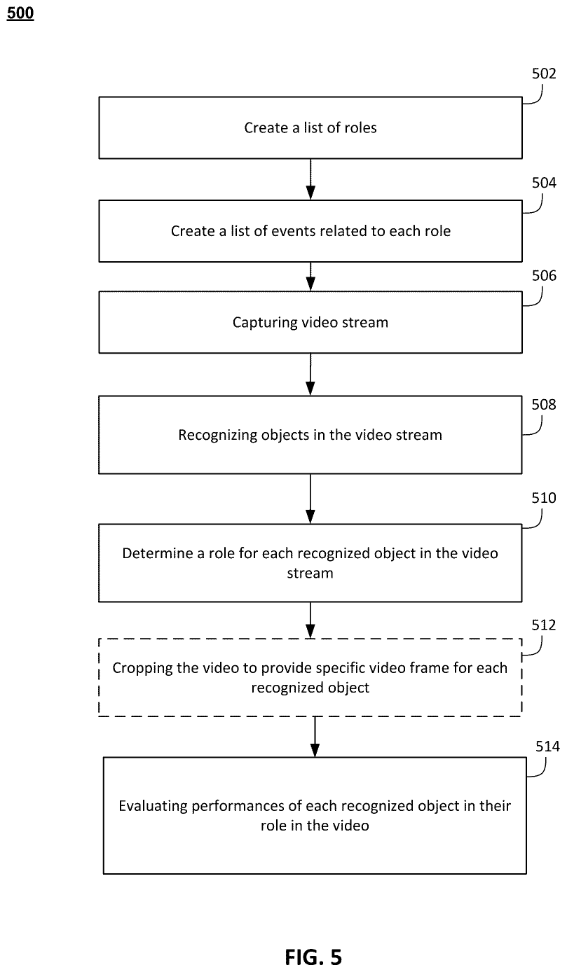

FIG. 5 is a flow diagram of a method for machine learning (ML)-based analysis of multiple simultaneous events in a video according to aspects of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). Identifying and detecting objects and/or people in an activity in a video, determining roles for each identified object and/or person in the video, and evaluating the performance of each identified object and/or person in their role in the activity.

At 502, the method 500 may include obtaining or creating a list of roles for a particular activity. For example, during a NASCAR pit stop, each team member may play a particular role during the pit stop such as a jackman, front tire changer, rear tire changer, front tire carrier, rear tire carrier, fueler, utility man, crew chief, spotter, car chief, and pit crew coach. Each of these team members has a specific task to contribute to the pit stop activity including refueling, changing tires, and making minor adjustments. In addition, since these pit stops typically take between 12 to 15 seconds the team members must balance speed and precision. Mistakes such as a slow tire change or spilled fuel can be costly so each team member must work in synchronization. As an example, referring back to FIG. 1, the list or roles for a particular activity may be input into a simultaneous event module 110.

At 504, the method 500 may include obtaining or creating a list of events (or actions) related to each role. For example, during the NASCAR pit stop, the jackman is responsible for using a floor jack to raise each side of the car and then lowering the car after all tires are replaced, the front tire changer may involve using a pneumatic gun to remove and tighten the lug nuts on the front tires, and the rear tire changer may involve using a pneumatic gun to remove and tighten the lug nuts on the rear tires. As an example, referring back to FIG. 1, the actions 108 related to each role may be input into a simultaneous event module 110.

In some examples, the list of events or actions for each role may include allowed actions and/or prohibited actions.

At 506, the method 500 may include obtaining a video of one or more objects potentially involved in an activity and/or persons involved in an activity. As an example, referring back to FIG. 1, the video 104 may be input into a simultaneous event module 110 for analysis. As another example, referring back to FIGS. 2A and 2B, the video shows objects and/or team members involved the activity of a pit stop.

At 508, the method 500 may include identifying the one or more objects and/or persons in the video and objects that the one or more persons interact while performing the activity by analyzing the video using a trained object detection ML model (e.g., object detection model 427a shown in FIG. 4).

At 510, the method 500 may include determining a role for each object and/or person involved in the activity by analyzing actions of the object and/or interactions with the objects for each person by executing a trained role recognition ML model (e.g., role recognition model 427b shown in FIG. 4) in each video clip.

At 512, optionally, the method 500 may include cropping the video into a plurality of video clips, wherein each video clip shows a single person, actions performed by the single person, and all objects that the single person interacts with while performing the activity. In some aspects, cropping may include deleting (e.g., erasing) context out of the selected region. For example, a wheel may be the detected object in the video clip, and the video may be cropped to remove all events around the detected wheel. As another example, a mechanic may be the detected person in the video clip, and the video may be cropped to remove all events around the mechanic.

At 514, the method 500 may include evaluating a performance for each object and/or person in their role while performing the activity using a trained performance evaluation ML model (e.g., the evaluation module 427c shown in FIG. 4) by comparing the list of actions associated with the determined role with the actions involved in the object, performed by the single person and/or interactions with the objects for the single person in the video clip.

The method 500 may further include generating a dynamic UI for displaying synchronized videos clips of each object and/or person. Each synchronized video clip comprises at least a visual identifier corresponding to each object and/or a visual identifier of each person.

In some examples, the method 500 may further include: generating an overlay of an outline of the object and/or person in the synchronized video clip; and applying the generated overlay on each frame of the object and/or person in the synchronized video clips.

In some examples, the method 500 may include preparing the object detection ML model using a training dataset comprising of images of objects and an object label identifying each object in the images to visually detect and distinguish between different objects.

In some examples, the method 500 may include preparing the object detection ML model using a training dataset comprising of images of people and a name label identifying each person in the images to visually detect and distinguish between different people.

In some examples, the method 500 may include preparing a role recognition ML model using a training set comprising of images of objects involved in the activity and a role label identifying each object corresponding to actions involved with the object.

In some examples, the method 500 may include preparing a role recognition ML model using a training set comprising of images of people interacting with an object and a role label identifying each action corresponding to how the person interacts with an object.

In some examples, the method 500 may further include: applying a tracking algorithm for the objects on consecutive frames to identify where a particular object was at a particular time and where a particular person was at the particular time; and generating a list of bounding boxes for a range of video frames for each identified person and object. As an example, referring back to FIG. 2A-2B and 3, bounding boxes may be overlaid on the frame for each identified person and object.

In some examples, the method 500 may further include: cropping the video based on the list of bounding boxes; slicing the video to a video clip with a sliding window; applying the trained role recognition ML model on each shorter clip; and performing post-processing for the results of the trained role recognition ML model to select final event timing. As an example, referring back to FIG. 3, individual video clips may be cropped and sliced to generate a shorter video clip only showing a particular object and/or team member during the activity.

In some examples, the method 500 may further include labeling each individual video clip with a corresponding result of executing the role recognition model for each bounding box of the object and a position of the object and/or a person and a position of the person in relation to the identified object.

In some examples, the method 500 may further include executing a trained event detection ML model to recognizing specific role events in the video based at least in part on tracking the object and/or person in a sequence of frames of the video. The trained event detection ML model is trained to identify objects and actions involving the object and/or people and their interaction with objects in the video using an events training set comprising of a sequence of frames containing an action involving the object, an action performed by a person with an object, and an event label identifying the objects and/oraction in the sequence of frames of the video.

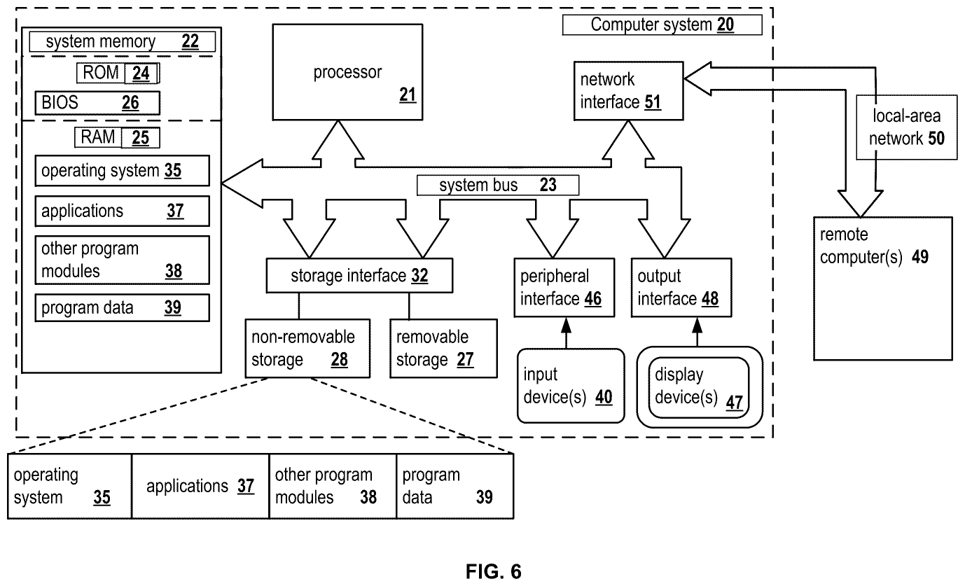

FIG. 6 is a block diagram illustrating a computer system 20 on which aspects of systems and methods machine learning (ML)-based analysis of multiple simultaneous events in a video may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for machine learning (ML)-based analysis of multiple simultaneous events in a video, the method comprising:
obtaining a video of one or more objects potentially involved in an activity;
identifying the one or more objects in the video by analyzing the video using a trained object detection ML model;
cropping the video into a plurality of video clips, wherein each video clip shows a single object or related group of objects, actions performed by the object, and selected objects interacted with while performing the activity;
obtaining a list of roles for the activity and a list of actions associated with each role;
determining a role for each object involved in the activity by analyzing actions and/or interactions with the objects for each object by executing a trained role recognition ML model in each video clip; and
evaluating a performance for object in the determined role while performing the activity using a trained performance evaluation ML model by comparing the list of actions associated with the determined role with the actions performed by the object and/or interactions with the objects for the single object in the video clip.

2. The method of claim 1, further comprising:
identifying objects that one or more persons interact with while performing the activity by analyzing the video using the object detection ML model;
cropping the video into the plurality of video clips, wherein each video clip further shows a single person and all objects that the one or more person interacts with while performing the activity;
determining a role for each person involved in the activity by analyzing actions and/or interactions with the objects for each person by executing the trained role recognition ML model in each video clip; and
evaluating the performance for each person in the determined role while performing the activity using the trained performance evaluation ML model by comparing the list of actions associated with the determined role with the actions performed by the person and/or interactions with the objects for the person in the video clip.

3. The method of claim 1, wherein the list of actions for each role comprises allowed actions and/or prohibited actions.

4. The method of claim 1, further comprising:
generating a dynamic UI for displaying synchronized videos clips of each object or person, wherein each synchronized video clip comprises at least a visual identifier of each person or a visual identifier corresponding to each object.

5. The method of claim 4, further comprising:
generating an overlay of an outline of the person or object in the synchronized video clip; and
applying the generated overlay on each frame of the person or object in the synchronized video clips.

6. The method of claim 1, further comprising:
preparing the object detection ML model using a training dataset comprising of images of objects and a name label identifying each object in the images to visually detect and distinguish between different objects.

7. The method of claim 2, further comprising:
preparing the object detection ML model using a training dataset comprising of images of people and an person label identifying each person in the images to visually detect and distinguish between different people.

8. The method of claim 1, further comprising:
preparing a role recognition ML model using a training set comprising of images of objects interacting with an object or person and a role label identifying each action corresponding to how the object interacts with another object or person.

9. The method of claim 1, further comprising:
applying a tracking algorithm for the objects on consecutive frames to identify where a particular object was at a particular time or where a particular person was at the particular time; and
generating a list of bounding boxes for a range of video frames for each identified object or person.

10. The method of claim 9, further comprising:
cropping the video based on the list of bounding boxes;
slicing the video to a video clip with a sliding window;
applying the trained role recognition ML model on each shorter clip; and
performing post-processing for the results of the trained role recognition ML model to select final event timing.

11. The method of claim 9, further comprising:
labeling each individual video clip with a corresponding result of executing the role recognition model for each bounding box of the object or person and a position of the object or person in relation to another object.

12. The method of claim 1, further comprising:
executing a trained event detection ML model to recognizing specific role events in the video based at least in part on tracking the object or person in a sequence of frames of the video, wherein the trained event detection ML model is trained to identify objects or people and the determined interaction with objects in the video using an events training set comprising of a sequence of frames containing an action performed by an object with another object or a person with an object and an event label identifying the action in the sequence of frames of the video.

13. A system for machine learning (ML)-based analysis of multiple simultaneous events in a video, comprising:
at least one memory; and
at least one hardware processor coupled with the at least one memory and configured, individually or in combination, to:
obtain a video of one or more objects potentially involved in an activity;
identify the one or more objects in the video by analyzing the video using a trained object detection ML model;
crop the video into a plurality of video clips, wherein each video clip shows a single object or related group of objects, actions performed by the object, and selected objects interacted with while performing the activity;
obtain a list of roles for the activity and a list of actions associated with each role;
determine a role for each object involved in the activity by analyzing actions and/or interactions with the objects for each object by executing a trained role recognition ML model in each video clip; and
evaluate a performance for object in the determined role while performing the activity using a trained performance evaluation ML model by comparing the list of actions associated with the determined role with the actions performed by the object and/or interactions with the objects for the single object in the video clip.

14. The system of claim 13, wherein the at least one hardware processor is further coupled with the at least one memory and configured, individually or in combination, to
identify objects that one or more persons interact with while performing the activity by analyzing the video using the object detection ML model;
crop the video into the plurality of video clips, wherein each video clip further shows a single person and all objects that the one or more person interacts with while performing the activity;
determine a role for each person involved in the activity by analyzing actions and/or interactions with the objects for each person by executing the trained role recognition ML model in each video clip; and
evaluate the performance for each person in the determined role while performing the activity using the trained performance evaluation ML model by comparing the list of actions associated with the determined role with the actions performed by the person and/or interactions with the objects for the person in the video clip.

15. The system of claim 13, wherein the list of actions for each role comprises allowed actions and/or prohibited actions.

16. The system of claim 13, wherein the at least one hardware processor is further coupled with the at least one memory and configured, individually or in combination, to
generate a dynamic UI for displaying synchronized videos clips of each object or person, wherein each synchronized video clip comprises at least a visual identifier of each person or a visual identifier corresponding to each object.

17. The system of claim 16, wherein the at least one hardware processor is further coupled with the at least one memory and configured, individually or in combination, to
generate an overlay of an outline of the object or in the synchronized video clip; and
apply the generated overlay on each frame of the person or object in the synchronized video clips.

18. The system of claim 13, wherein the at least one hardware processor is further coupled with the at least one memory and configured, individually or in combination, to:
prepare the object detection ML model using a training dataset comprising of images of objects and a name label identifying each object in the images to visually detect and distinguish between different objects.

19. The system of claim 13, wherein the at least one hardware processor is further coupled with the at least one memory and configured, individually or in combination, to:
prepare the object detection ML model using a training dataset comprising of images of objects and an object label identifying each object in the images to visually detect and distinguish between different objects.

20. A non-transitory computer readable medium storing thereon computer executable instructions for machine learning (ML)-based analysis of multiple simultaneous events in a video, including instructions for:
obtaining a video of one or more objects potentially involved in an activity;
identifying the one or more objects in the video by analyzing the video using a trained object detection ML model;
cropping the video into a plurality of video clips, wherein each video clip shows a single object or related group of objects, actions performed by the object, and selected objects interacted with while performing the activity;
obtaining a list of roles for the activity and a list of actions associated with each role;
determining a role for each object involved in the activity by analyzing actions and/or interactions with the objects for each object by executing a trained role recognition ML model in each video clip; and
evaluating a performance for object in the determined role while performing the activity using a trained performance evaluation ML model by comparing the list of actions associated with the determined role with the actions performed by the object and/or interactions with the objects for the single object in the video clip
